(19) United States
(12) Patent Application Publication
(10) Pub. No.: US 2010/0313357 A1
(43) Pub. Date: Dec. 16, 2010

(54) Medical Bed Structure

(76) Inventor: Wen-Lung CHANG, Zhongli City , Taoyuan County (TW)

Correspondence Address: HDLS IPR Services, PO Box 220746, Chantilly, VA, 20153, US

(21) Appl. No.: 12/483,389

(22) Filed: Jun. 12, 2009

(51) Int. Cl. A61G 7/02

(52) U.S. Cl. 5/604

(57) ABSTRACT

A medical bed structure includes a bed frame. The bed frame is provided with a plurality of spray nozzles on its edge. The bottom of the bed frame is formed with a discharge hole and a cleaning set on the discharge hole. The spray nozzles are capable of spraying water for cleaning. The discharge hole is adapted to discharge feces. The cleaning set is adapted to clean the anus of the patient after having a bowel movement. The present invention provides a patient who lies in bed for a long period of time to take a bath and to clean the feces automatically.

### BACKGROUND OF THE INVENTION

1. Field of the Invention

The present invention relates to a medical bed structure, and more particularly to one having spray nozzles, a discharge hole and a cleaning set.

2. Description of the Prior Art

It is a laborious job for a health care staff to clean a patient who lies on the bed over a long period of time because the patient is paralytic. The health care staff needs the assistance of another person to move the patient to a bath or a lavatory. Some patients are unable to speak that he/she wants to have a bowel movement, so the feces soil the bed. The health care staff has to clean the bed.

Accordingly, the inventor of the present invention has devoted himself based on his many years of practical experiences to the development of a medical bed structure for improving the quality of medical treatment and lightening the health care worker's burden.

### SUMMARY OF THE INVENTION

The primary object of the present invention is to provide an improved bed structure for cleaning a patient who lies on the bed. Furthermore, the patient is able to have a bowel movement on the bed directly. The present invention further comprises a cleaning device for cleaning the anus.

According to the present invention, there is provided a medical bed structure comprising a bed frame with a recess, the bed frame having two inner walls provided with at least one spray nozzle and a bottom formed with a discharge hole, an inner edge of the discharge hole being provided with a sensing element and a cleaning outlet.

The present invention provides a health care worker to clean a patient who lies on the bed with the spray nozzles to spray water. If the patient has a bowel movement, the feces are drained through the discharge hole. When the sensing element detects the feces passing through the discharge hole, the cleaning outlet is started to spray water for cleaning the excretory organ. The present invention provides an automatic cleaning and saves manpower.

### BRIEF DESCRIPTION OF THE DRAWINGS

FIG. 1 is an exploded view of the present invention;

FIG. 2 is an enlarged view of a cushion having a through hole, pores and grooves of the present invention;

FIG. 3 is an enlarged view of a discharge hole provided with a sensing element and a cleaning outlet of the present invention;

FIG. 4 is a perspective view of the present invention;

FIG. 5 is a schematic view of the present invention showing a bed frame in an inclined status;

FIG. 6 is a schematic view of the present invention showing a curtain pulled out and a movable portion lifted;

FIG. 7 is a top view of the present invention showing water sprayed from spray nozzles when taking a bath;

FIG. 8 is a schematic view of the present invention showing the water drained out through first drain holes after bathing;

FIG. 9 is a schematic view of the present invention showing air blowing from the pores and flowing through the grooves;

FIG. 10 is a schematic view of the present invention showing the sensing element to detect the discharge hole;

FIG. 11 is a schematic view of the present invention showing the cleaning outlet being started to spray water for cleaning; and

FIG. 12 is a schematic view of the present invention showing an alarm unit to remind a health care staff of checking a container.

### DETAILED DESCRIPTION OF THE PREFERRED EMBODIMENT

Embodiments of the present invention will now be described, by way of example only, with reference to the accompanying drawings.

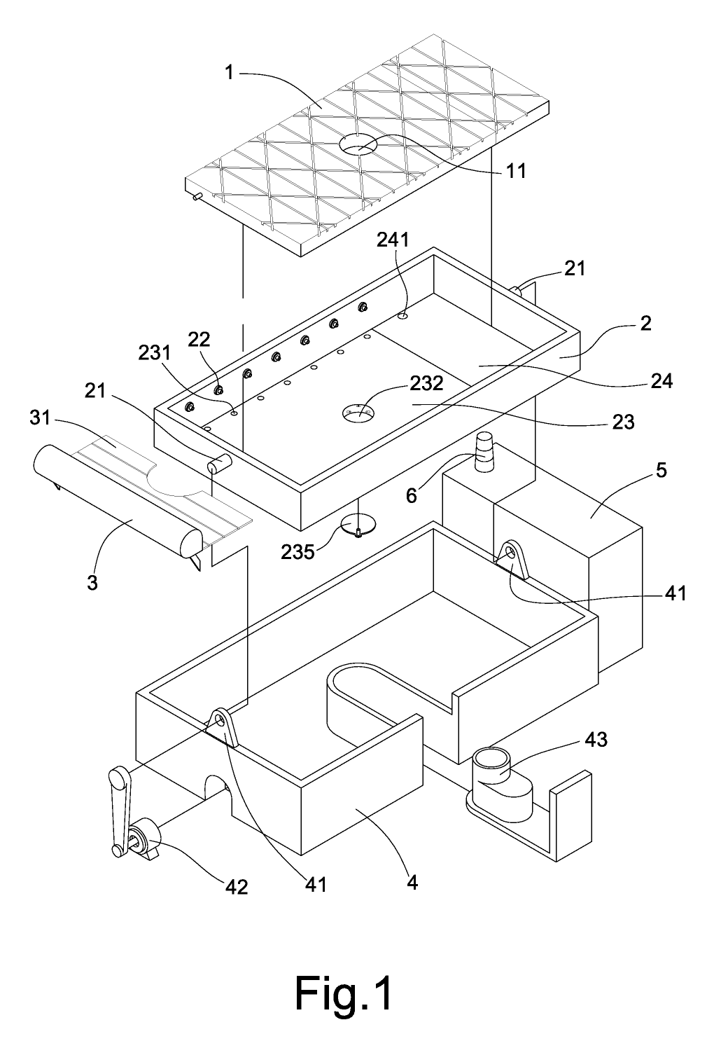

As shown in FIGS. 1 through 4, a medical bed structure of the present invention comprises a cushion 1, a bed frame 2, a covering unit 3, a base 4, a water reservoir 5, and an alarm unit 6.

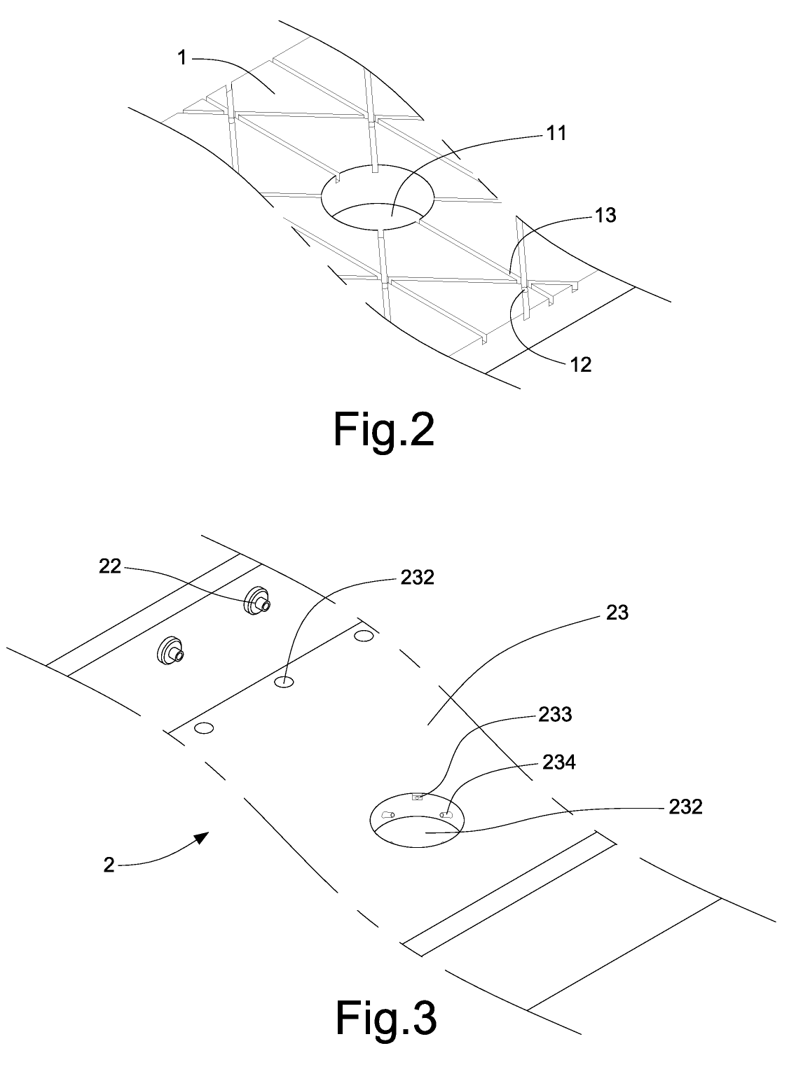

The cushion 1 is made of soft material in a rectangular shape for a patient to lie thereon. The cushion 1 is formed with a through hole 11 corresponding in position to the anus of the patient. The cushion 1 has an upper surface formed with a plurality of pores 12 and grooves 13 which are interconnected with each other, as shown in FIG. 2.

The bed frame 2 is in a rectangular shape with a recess to receive the cushion 1 therein. The bed frame 2 has a pair of short sides and a pair of long sides. The bed frame 2 comprises a pair of extension shafts 21 on outer surfaces of the pair of short sides, a plurality of spray nozzles 22 on inner surfaces of the pair of long sides, and a bottom. The bottom of the bed frame 2 has a fixed portion 23 and a movable portion 24. The fixed portion 23 is formed with a plurality of first drain holes 231 around its periphery and a discharge hole 232 corresponding in position to the through hole 11. A sensing element 233 and a cleaning outlet 234 are provided on an inner edge of the discharge hole 23, as shown in FIG. 3. A movable lid 235 is provided underneath the discharge hole 232. The movable portion 24 has one side connected to the fixed portion 23 as a turning axle for rising at a certain angle. The movable portion 24 is formed with second drain holes 241 at respective two sides thereof.

The covering unit 3 is a roller curtain device coupled to the outer surface of one of the short sides of the bed frame 2. The covering unit 3 comprises a curtain 31 which is extendable to cover the bed frame 2.

The base 4 is in a rectangular shape and has a pair of short sides provided with braces 41 for connection of the extension shafts 21. The base 4 further comprises a power unit 42 coupled to the end of the extension shaft 21 and a container 43 corresponding in position to the discharge hole 232.

The water reservoir 5 is adapted to store liquid therein and disposed at a proper periphery of the base 4. The water reservoir 5 has pipes connected to the base 4 for supplying water.

The alarm unit 6 is a luminous apparatus disposed on the water reservoir 5. The alarm unit 6 is adapted to receive a signal from the sensing element 233.

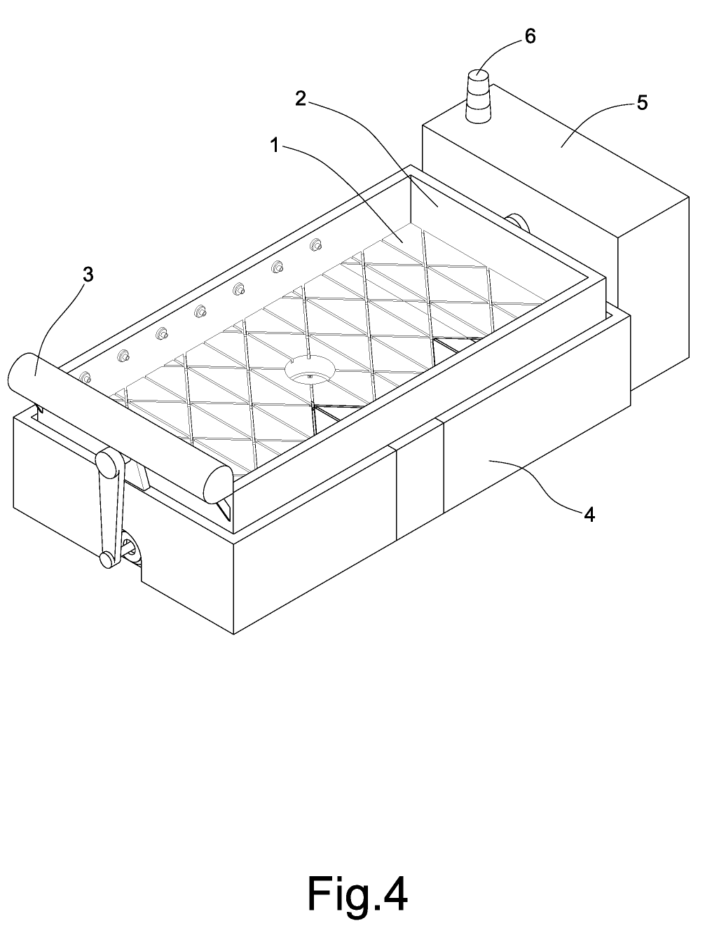

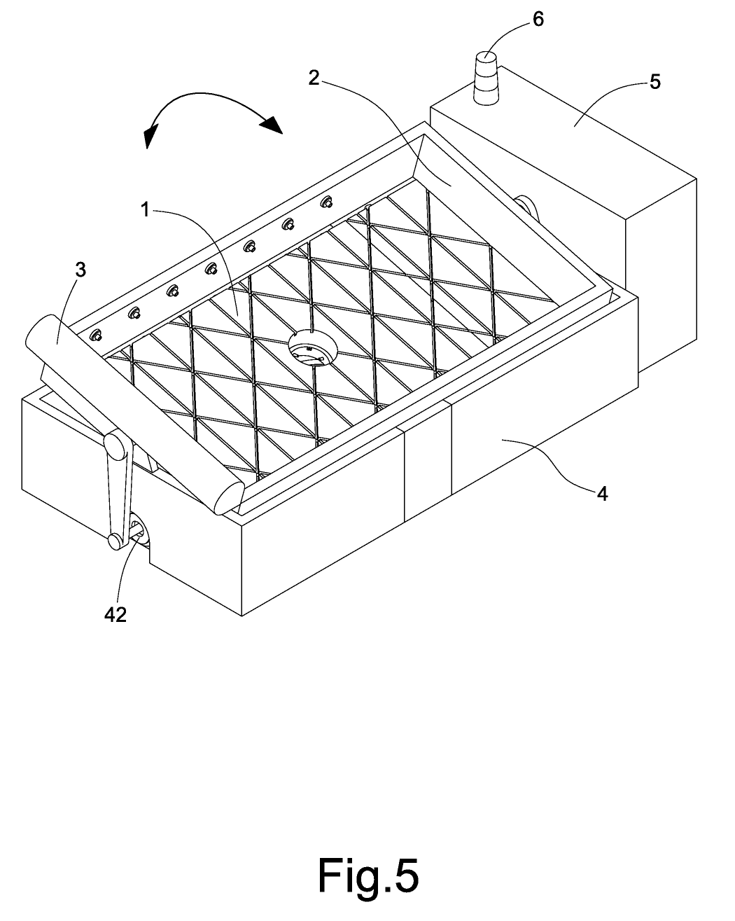

FIG. 4 is a perspective view of the present invention. FIG. 5 is a schematic view of the present invention showing the bed frame in an operating status. The power unit 42 drives the extension shafts 21 to tilt the bed frame 2 so that the patient gets into bed or out of bed easily.

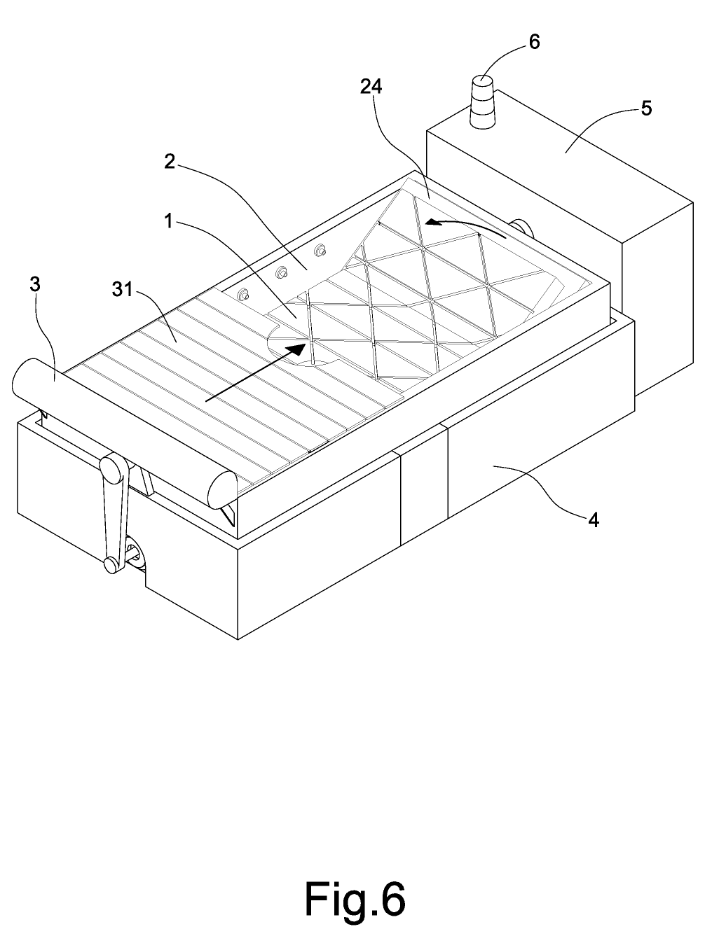

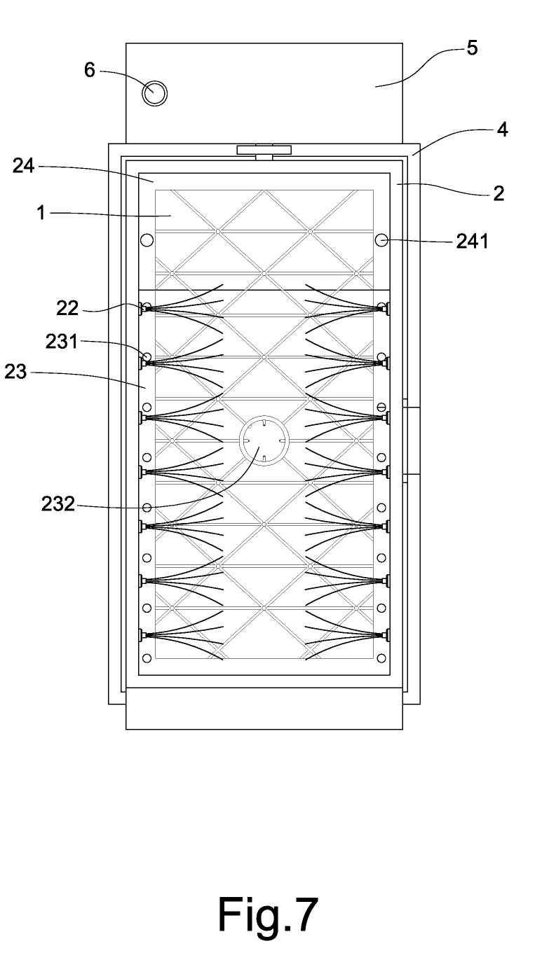

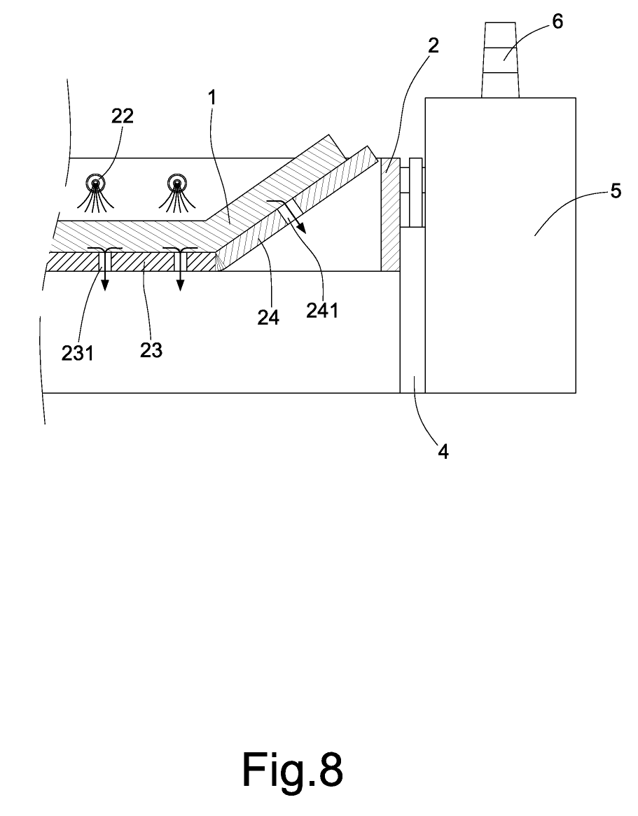

As shown in FIG. 6, the curtain 31 is pulled out to cover the bed frame 2 and the movable portion 24 is lifted. When the patient lies on the bed frame 2 for taking a bath, the curtain 31 is used to shelter the patient's body and prevent water from splashing. The movable portion 24 is adapted to lift the patient's head. FIGS. 7 and 8 are schematic views showing the spray nozzles 22 spraying water for bathing. As shown in FIG. 8, the water is drained out through the first drain holes 231 after bathing. The second drain holes 241 of the movable portion 24 is used to drain the water flowing from the patient's head, preventing the water from submerging the patient's head to cause an accident.

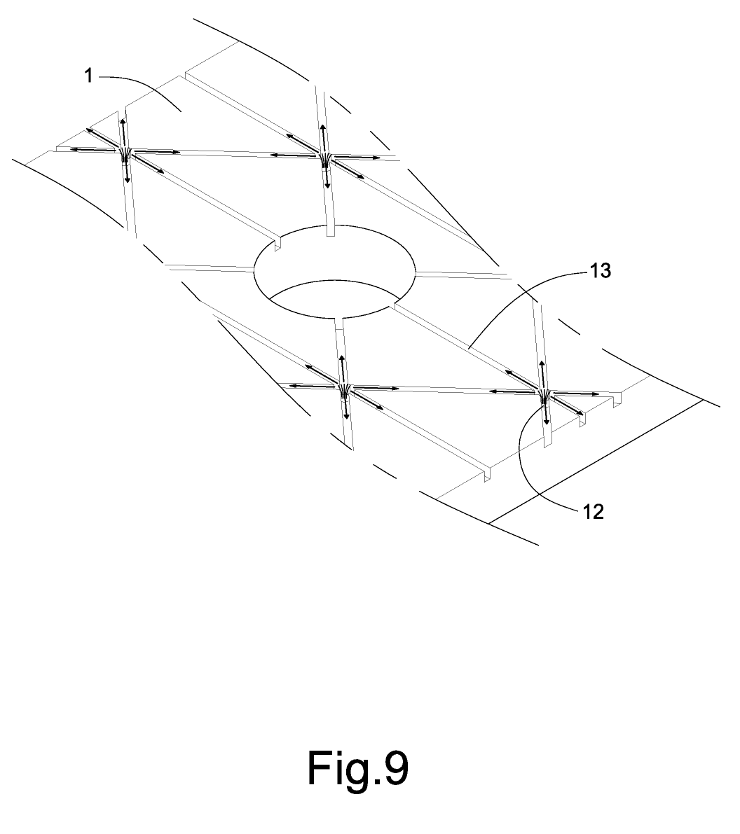

FIG. 9 is a schematic view showing air blowing from the pores 12 for drying the patient's body after bathing. The air flows through the grooves 13 for circulation.

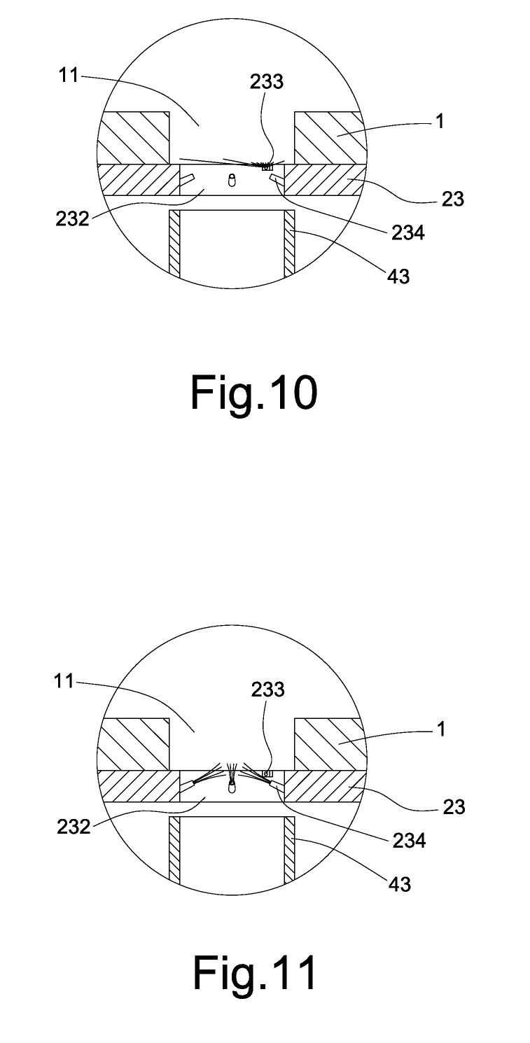

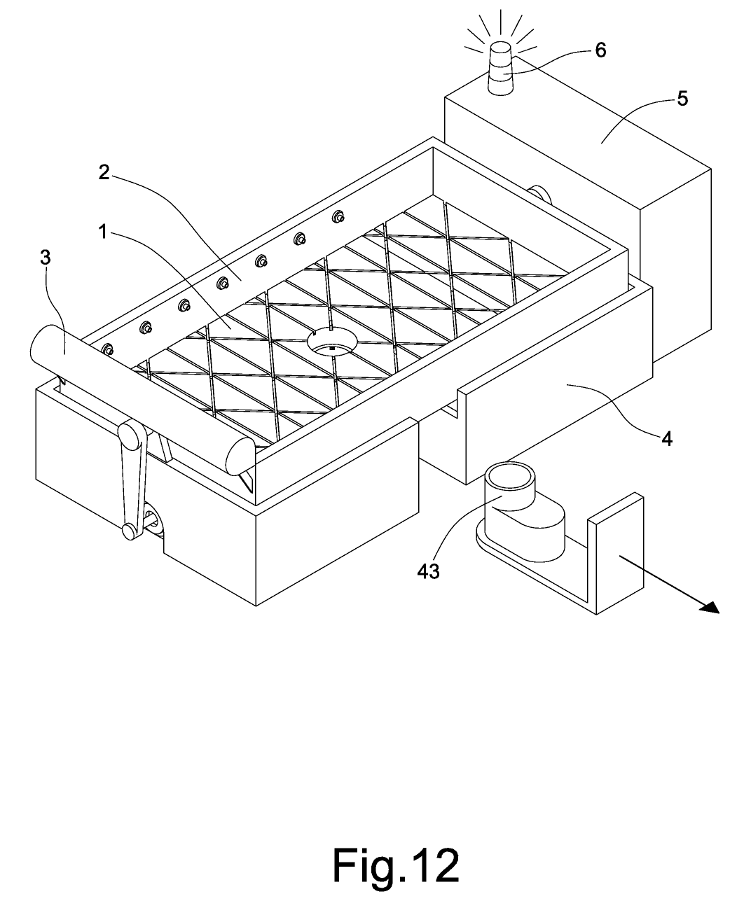

As shown in FIGS. 10 through 12, the sensing element 233 is to detect the discharge hole 232, referring to FIG. 10. If there are feces passing through the discharge hole 232, the cleaning outlet 234 is automatically started to spray water for cleaning the patient's anus, as shown in FIG. 11. The feces and the sewage flow into the container 43 directly. The sensing element 233 sends a signal to the alarm unit 6 for reminding a health care staff of checking the container 43.

The present invention provides a patient who lies on the bed for a long period of time to take a bath or to have a bowel movement on the bed frame 2 directly, achieving automatic cleaning and manpower saving effects.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A medical bed structure, comprising a bed frame with a recess, the bed frame having two inner walls provided with at least one spray nozzle and a bottom formed with a discharge hole, an inner edge of the discharge hole being provided with a sensing element and a cleaning outlet.

2. The medical bed structure as claimed in claim 1, wherein the bottom of the bed frame is formed with first drain holes.

3. The medical bed structure as claimed in claim 1, wherein the bottom of the bed frame comprises a fixed portion and a movable portion, the movable having a side connected to the fixed portion as a turning axle, the movable portion being formed with a second drain hole, the discharge hole being disposed on the fixed portion.

4. The medical bed structure as claimed in claim 1, wherein the recess of the bed frame is adapted to receive a cushion therein, the cushion having a through hole, pores and grooves thereon.

5. The medical bed structure as claimed in claim 4, wherein the through hole of the cushion corresponds in position to the discharge hole of the bed frame.

6. The medical bed structure as claimed in claim 1, wherein the bed frame is coupled to a base.

7. The medical bed structure as claimed in claim 6, wherein the bed frame comprises a pair of extension shafts disposed on outer surfaces of two sides thereof and a power unit connected to one of the extension shafts.

8. The medical bed structure as claimed in claim 6, wherein the base has a container.

9. The medical bed structure as claimed in claim 8, wherein the container is located under the discharge hole of the bed frame.

10. The medical bed structure as claimed in claim 1, wherein the bed frame is provided with a pipe connected to a water reservoir, the sensing element is electrically connected to an alarm unit.
